(19) United States
(12) Patent Application Publication
(10) Pub. No.: US 2023/0110849 A1
(43) Pub. Date: Apr. 13, 2023

(54) METHOD AND SYSTEM FOR DETERMINING A PLANT PROTECTION TREATMENT PLAN OF AN AGRICULTURAL PLANT

(71) Applicant: BASF AGRO TRADEMARKS GMBH, Ludwigshafen (DE)

(72) Inventors: Priyamvada SHANKAR, Köln (DE); Andreas JOHNEN, Münster (DE); Diego Armando MORALES CEPEDA, Münster (DE); Ole JANSSEN, Köln (DE)

(21) Appl. No.: 17/910,073

(22) PCT Filed: Mar. 12, 2021
(86) PCT No.: PCT/EP2021/056340

§ 371 Date: Sep. 8, 2022

(30) Foreign Application Priority Data
Mar. 13, 2020 (EP) 20163178.5

(51) Int. Cl. G06Q 50/02; G06Q 10/04; G06Q 10/06

(52) U.S. Cl. CPC G06Q 50/02; G06Q 10/04; G06Q 10/06

(57) ABSTRACT

The present application provides a method for determining a plant protection treatment plan of an agricultural plant, the method carried out by a data processing unit (111), and the method comprising the steps of: obtaining (S110), by the data processing unit, plant observation data indicative for a current state of health of the agricultural plant or of a reference plant, obtaining (S120), by the data processing unit, weather data associated with a location at which the agricultural plant is cultivated, predicting (S130), by a computational model (113) executed by the data processing unit, based on the obtained observation data and the obtained weather data, a time-related disease probability of the agricultural plant, and determining (S140), by the computational model (113), based on at least the predicted disease probability, at least one plant protection treatment parameter to be included in the plant protection treatment plan.

The present application relates to computer-aided agricultural plant treatment. In particular, the present application relates to a method and a device for determining a plant protection treatment plan of an agricultural plant. Further, the present application relates to a method for adapting a computational model to changed conditions of cultivation of an agricultural plant for determining, by use of the adapted computational model, a plant protection treatment plan for the agricultural plant, and a system for treating an agricultural plant based on a plant protection treatment plan assigned to the agricultural plant.

In agriculture, cultivated plants, in particular crops, can be affected by diseases occurring between seeding and harvest, which may diminish the yield. Thereby, plant disease occurrence is mainly driven by three factors, namely the host plant, which affects plant specific vulnerabilities, the pathogen, which represents a disease causing agent, and the environmental conditions, which may comprise disease favoring weather. Mainly these three factors drive disease occurrence, wherein the development of the disease is a dynamic process between these factors. This complex relationship of factors alone makes plant disease management a challenge. At the same time, agriculture faces a challenge of feeding a growing population expected to rise to 9 billion by 2050, so that agriculture should be as efficient as possible. And, there is growing scarcity of important resources like land, water and biodiversity. This combined with effects of climate change leads to more frequent extreme weather events and an increase in plant pests and diseases, making agriculture a challenge.

However, plants can be kept healthy with plant protection measures or treatment, such as the application of plant protection agents, pesticides, or the like. Nevertheless, it is a challenge, for example, to determine the most appropriate time for plant protection measures, to identify the appropriate plant protection agent, to determine an optimal quantity of the plant protection agent, etc.

Therefore, there may still be a need for providing more efficient and effective means for supporting agriculture in disease and/or health management of plants. It is accordingly an object of the present invention to provide more efficient and effective means for supporting agriculture in disease and/or health management of plants.

A first aspect of the invention provides a, preferably computer-implemented, method for determining a plant protection treatment plan of an agricultural plant, e.g. a crop. The method is to be carried out by a data processing unit, which may be a processor, a computer device, or the like. The method may be implemented in computer program instructions, e.g. provided as a computer program element, and may be performed, for example, by one or more data processing units and/or computer devices. It may also be carried out by one or more computer devices of a distributed computer system. Such a distributed computer system may particularly comprise a computing cloud, a client-server system or the like, and a plant cultivation-site computer device. This means that the distributed computer system may be implemented centrally via cloud computing and/or remotely, via edge computing, at the plant cultivation-site.

The method may be carried out either centrally or remotely or a combination of centrally and remotely. In some embodiments, it may be contemplated that individual computation steps can be processed on different processing units. The computer devices may comprise a data processor, a memory for storing a computer program element, a data interface, a communication interface, etc. As used herein, data or information may be provided and/or exchanged in electronic form, e.g. as signals, data packets, etc., and may be processed electronically by the above data processing unit or computer device. Data exchange may be carried out via a communications network, such as the Internet.

The method for determining a plant protection treatment plan of an agricultural plant comprises the steps of:
Obtaining, by the data processing unit, plant observation data indicative for a current state of health of the agricultural plant or of a reference plant. The plant observation data may comprise one or more individual data, which may also be subject of a data fusion. Observation data need not necessarily be obtained from a direct observation, but may be determined indirectly from a database, data set, combining different data sources, etc. Some or all of the above data may also be combined or merged with one another.
Obtaining, by the data processing unit, weather data associated with a location at which the agricultural plant is cultivated. As explained above, environmental conditions of the plant typically may affect the health of the plant or, respectively, the development of diseases. The weather data may be obtained from a weather database, weather records, a weather forecasting service, weather measurements, from satellite data, or the like. The weather data may also be obtained indirectly through an indication of the geographical location of the plant. Further, the weather data may comprise one or more of a temperature, humidity, etc. The location may be indicated e.g. by location coordinates, location identifier, location name, such as the name of a region, city, town etc. Preferably, the weather data and the location may be correlated with each other, mapped, combined, or the like.
Predicting, by a computational model executed by the data processing unit, based on input data at least comprising the obtained observation data and the obtained weather data, a time-related disease probability of the agricultural plant. In other words, a prediction and/or estimation and/or forecast is made for the future, i.e. in a time-related manner, as to whether and, optionally, if so, to what extent a plant disease is to be expected or at least likely. A computational model may be broadly understood, and in particular as a mathematical model utilized in computational science that requires computational resources, e.g. provided by the above data processing unit, to study the behavior of a complex system, e.g. the agricultural cultivation of plants, and in particular the probability of plant diseases, by e.g. computer simulation. Further, the computational model may be a machine learning model. As used herein, disease probability may comprise one or more of disease severity, disease incident, disease risk, or the like. Thereby, disease severity may be understood as the amount of disease, or the amount of an indicator for the disease, such as the reflectance from the plant and/or visible changes on the plant, e.g. spots or the like, that is visible on a plant, so that it may also be observed and/or detected, e.g. manually by visual observation. Alternatively or additionally, it may also be observed and/or detected in an at least semi-automated manner, e.g. by using a robotic detection device, such as an aircraft, e.g. a drone, an agricultural vehicle, having detection means, and/or by means of satellite images, etc. In at least some embodiments, disease detection may be based on a so-called normalized difference vegetation index (NDVI) and/or leaf area index (LAI), which is a graphical indicator and/or a one-sided green leaf area per unit ground surface area, adapted to be used to analyze, e.g. remote sensing, local measurements for assessing whether or not the plant being observed contains live green vegetation. Further, disease severity may be understood as a result of a given infection risk over a period of time, e.g. days. With regard to disease severity, for example, the detection of disease on the upper leaves of the plant may be of particular interest. This can have a significant effect on yield.
Determining, by the computational model, based on at least the predicted disease probability, at least one plant protection treatment parameter to be included in the plant protection treatment plan. The plant protection treatment parameter and/or the plant protection plan may also referred to as output data of the computational model and/or a result of the method. It may be subsequently used as input data for an interrelated apparatus and/or system, which can further process these data or can be operated on the basis of these data. For example, Further, the plant protection treatment parameter and/or the plant protection plan may be displayed to and/or logged for a user, such as an agricultural company, a farmer, or the like. Furthermore, the plant protection treatment parameter and/or the plant protection plan may be used as a trigger, e.g. a trigger signal, message, etc., adapted to trigger plant protection measures or treatment, which can be carried out at least partially automated, e.g. by using a robot, which may be an at least semi-automated and/or remotely controllable device, such as an agricultural vehicle, an aircraft, e.g. a drone, having detection means.

As used herein, a plant disease may be any undesirable or devastating plant disease and/or devastating crop disease. By way of example, plant diseases may be assigned to or caused by one or more of the following agents: Phytopathogenic fungi, including soil-borne fungi, in particular from the classes of Plasmodiophoromycetes, Peronosporomycetes (syn. Oomycetes), Chytridiomycetes, Zygomycetes, Ascomycetes, Basidiomycetes, and Deuteromycetes (syn. Fungi imperfecti). The method described here is particularly well suited for use in connection with the disease Septoria Tritici, or the like. Such a disease may have an impact on e.g. the yield of the plant. The impact on the yield may be particularly large when the disease reaches one of the top leaves, and in particular one of the three top leaves. Therefore, the method may also be capable of mapping the predicted plant protection treatment parameter to leaf layer specific estimation.

The method allows for adjusting rules for determining the plant protection treatment parameter and/or the plant protection plan in an automated manner. This means that the method, and in particular the model used for this method, can be adapted to different situations. For example, it may be adapted to e.g. a new location of cultivation, such as a new region, changing weather conditions, climate change, new or changed diseases, or the like, without the intervention of a human expert. Therefore, the method allows to optimize timing the application of e.g. plant protection agents, pesticides, or the like, so that agricultural companies, farmers, etc. only apply the actual quantity, i.e. the smallest possible quantity to the plant and thus protecting yield, saving costs and the environment.

For example, by use of the method according to the second aspect, the computational model may be adapted to other diseases. By way of example, plant diseases that may then be predicted can be assigned to or be caused by one or more of the following agents:

Albugo spp. (white rust) on ornamentals, vegetables (e. g. A. candida) and sunflowers (e. g. A. tragopogonis); Alternaria spp. (Alternaria leaf spot) on vegetables (e.g. A. dauci or A. porri), oilseed rape ( A. brassicicola or brassicae), sugar beets ( A . tenuis), fruits (e.g. A. grandis), rice, soybeans, potatoes and tomatoes (e. g. A. solani, A. grandis or A. alternata), tomatoes (e. g. A. solani or A. alternata) and wheat (e.g. A. triticina); Aphanomyces spp. on sugar beets and vegetables; Ascochyta spp. on cereals and vegetables, e. g. A. tritici (anthracnose) on wheat and A. hordeion barley; Aureobasidium zeae (syn. Kapatiella zeae) on corn; Bipolaris and Drechslera spp. (teleomorph: Cochliobolus spp.), e. g. Southern leaf blight ( D. maydis) or Northern leaf blight ( B. zeicoia) on corn, e. g. spot blotch ( B. sorokiniana) on cereals and e. g. B. oryzae on rice and turfs; Blumeria (formerly Erysiphe) graminis (powdery mildew) on cereals (e. g. on wheat or barley); Botrytis cinerea (teleomorph: Botryotinia fuckeliana: grey mold) on fruits and berries (e. g. strawberries), vegetables (e. g. lettuce, carrots, celery and cabbages); B. squamosa or B. allii on onion family, oilseed rape, ornamentals (e.g. B eliptica), vines, forestry plants and wheat; Bremia lactucae (downy mildew) on lettuce; Ceratocystis (syn. Ophiostoma) spp. (rot or wilt) on broad-leaved trees and evergreens, e. g. C. ulmi (Dutch elm disease) on elms; Cercosporaspp. (Cercospora leaf spots) on corn (e. g. Gray leaf spot: C. zeae-maydis), rice, sugar beets (e. g. C. beticola), sugar cane, vegetables, coffee, soybeans (e. g. C. sojina or C. kikuchii) and rice; Cladobotryum (syn. Dactylium) spp. (e.g. C. mycophilum (formerly Dactylium dendroides, teleomorph: Nectria albertinii, Nectria rosella syn. Hypomyces rosellus) on mushrooms; Cladosporium spp. on tomatoes (e. g. C. fulvum: leaf mold) and cereals, e. g. C. herbarum (black ear) on wheat; Claviceps purpurea (ergot) on cereals; Cochliobolus (anamorph: Helminthosporium of Bipolaris) spp. (leaf spots) on corn ( C. carbonum), cereals (e. g. C. sativus, anamorph: B. sorokiniana) and rice (e. g. C. miyabeanus, anamorph: H. oryzae); Colletotrichum (teleomorph: Glomerella) spp. (anthracnose) on cotton (e. g. C. gossypii), corn (e. g. C. graminicola: Anthracnose stalk rot), soft fruits, potatoes (e. g. C. coccodes: black dot), beans (e. g. C. lindemuthianum), soybeans (e. g. C. truncatum or C. gloeosporioides), vegetables (e.g. C. lagenarium or C. capsici), fruits (e.g. C. acutatum), coffee (e.g. C. coffeanum or C. kahawae) and C. gloeosporioides on various crops; Corticium spp., e. g. C. sasakii (sheath blight) on rice; Corynespora cassiicola (leaf spots) on soybeans, cotton and ornamentals; Cycloconium spp., e. g. C. oleaginum on olive trees; Cylindrocarpon spp. (e. g. fruit tree canker or young vine decline, teleomorph: Nectria or Neonectria spp.) on fruit trees, vines (e. g. C. liriodendri, teleomorph: Neonectria liriodendri: Black Foot Disease) and ornamentals; Dematophora (teleomorph: Rosellinia) necatrix (root and stem rot) on soybeans; Diaporthe spp., e. g. D. phaseolorum (damping off) on soybeans; Drechslera (syn. Helminthosporium, teleomorph: Pyrenophora) spp. on corn, cereals, such as barley (e. g. D. teres, net blotch) and wheat (e. g. D. tritici-repentis: tan spot), rice and turf; Esca (dieback, apoplexy) on vines, caused by Formitiporia (syn. Phellinus) punctata, F. mediterranea, Phaeomoniella chlamydospora (formerly Phaeoacremonium chlamydosporum), Phaeoacremonium aleophilum and/or Botryosphaeria obtusa; Elsinoe spp. on pome fruits ( E. pyri), soft fruits ( E. veneta: anthracnose) and vines ( E. ampelina: anthracnose); Entyloma oryzae (leaf smut) on rice; Epicoccum spp. (black mold) on wheat; Erysiphe spp. (powdery mildew) on sugar beets ( E. betae), vegetables (e. g. E. pisi), such as cucurbits (e. g. E. cichoracearum), cabbages, oilseed rape (e. g. E. cruciferarum); Eutypa lata (Eutypa canker or dieback, anamorph: Cytosporina lata, syn. Libertella blepharis) on fruit trees, vines and ornamental woods; Exserohilum (syn. Helminthosporium) spp. on corn (e. g. E. turcicum); Fusarium (teleomorph: Gibberella) spp. (wilt, root or stem rot) on various plants, such as F. graminearum or F. culmorum (root rot, scab or head blight) on cereals (e. g. wheat or barley), F. oxysporum on tomatoes, F. solani (f. sp. glycines now syn. F. virguliforme) and F. tucumaniae and F. brasiliense each causing sudden death syndrome on soybeans, and F. verticillioides on corn; Gaeumannomyces graminis (take-all) on cereals (e. g. wheat or barley) and corn; Gibberella spp. on cereals (e. g. G. zeae) and rice (e. g. G. fujikuroi: Bakanae disease); Glomerella cingulata on vines, pome fruits and other plants and G. gossypii on cotton; Grain-staining complex on rice; Guignardia bidwellii (black rot) on vines; Gymnosporangium spp. on rosaceous plants and junipers, e. g. G. sabinae (rust) on pears; Helminthosporium spp. (syn. Drechslera, teleomorph: Cochliobolus) on corn, cereals, potatoes and rice; Hemileia spp., e. g. H. vastatrix (coffee leaf rust) on coffee; Isariopsis clavispora (syn. Cladosporium vitis) on vines; Macrophomina phaseolina (syn. phaseoli) (root and stem rot) on soybeans and cotton; Microdochium (syn. Fusarium) nivale (pink snow mold) on cereals (e. g. wheat or barley); Microsphaera diffusa (powdery mildew) on soybeans; Monilinia spp., e. g. M. laxa, M. fructicola and M. fructigena (syn. Monilia spp.: bloom and twig blight, brown rot) on stone fruits and other rosaceous plants; Mycosphaerella spp. on cereals, bananas, soft fruits and ground nuts, such as e. g. M. graminicola (anamorph: Zymoseptoria tritici formerly Septoria tritici: Septoria blotch) on wheat or M. fijiensis (syn. Pseudocercospora fijiensis: black Sigatoka disease) and M. musicola on bananas, M. arachidicola (syn. M. arachidis or Cercospora arachidis), M. berkeleyi on peanuts, M. pision peas and M. brassiciola on brassicas; Peronospora spp. (downy mildew) on cabbage (e. g. P. brassicae), oilseed rape (e. g. P. parasitica), onions (e. g. P. destructor), tobacco ( P. tabacina) and soybeans (e. g. P. manshurica); Phakopsora pachyrhizi and P. meibomiae (soybean rust) on soybeans; Phialophora spp. e. g. on vines (e. g. P. tracheiphila and P. tetraspora) and soybeans (e. g. P. gregata: stem rot); Phoma lingam (syn. Leptosphaeria biglobosa and L. maculans: root and stem rot) on oilseed rape and cabbage, P. betae (root rot, leaf spot and damping-off) on sugar beets and P. zeae-maydis (syn. Phyllostica zeae) on corn; Phomopsis spp. on sunflowers, vines (e. g. P. viticola: can and leaf spot) and soybeans (e. g. stem rot: P. phaseoli, teleomorph: Diaporthe phaseolorum); Physoderma maydis (brown spots) on corn; Phytophthora spp. (wilt, root, leaf, fruit and stem root) on various plants, such as paprika and cucurbits (e. g. P. capsici), soybeans (e. g. P. megasperma, syn. P. sojae), potatoes and tomatoes (e. g. P. infestans: late blight) and broad-leaved trees (e. g. P. ramorum: sudden oak death); Plasmodiophora brassicae (club root) on cabbage, oilseed rape, radish and other plants; Plasmopara spp., e. g. P. viticola (grapevine downy mildew) on vines and P. halstedii on sunflowers; Podosphaera spp. (powdery mildew) on rosaceous plants, hop, pome and soft fruits (e. g. P. leucotricha on apples) and curcurbits ( P. xanthii); Polymyxa spp., e. g. on cereals, such as barley and wheat ( P. graminis) and sugar beets ( P. betae) and thereby transmitted viral diseases; Pseudocercosporella herpotrichoides (syn. Oculimacula yallundae, O. acuformis: eyespot, teleomorph: Tapesia yallundae) on cereals, e. g. wheat or barley; Pseudoperonospora (downy mildew) on various plants, e. g. P. cubensis on cucurbits or P. humili on hop; Pseudopezicula tracheiphila (red fire disease or ,rotbrenner’, anamorph: Phialophora) on vines; Puccinia spp. (rusts) on various plants, e. g. P. triticina (brown or leaf rust), P. striiformis (stripe or yellow rust), P. hordei (dwarf rust), P. graminis (stem or black rust) or P. recondita (brown or leaf rust) on cereals, such as e. g. wheat, barley or rye, P. kuehnii (orange rust) on sugar cane and P. asparagi on asparagus; Pyrenopeziza spp., e.g. P. brassicae on oilseed rape; Pyrenophora (anamorph: Drechslera) tritici-repentis (tan spot) on wheat or P. teres (net blotch) on barley; Pyricularia spp., e. g. P. oryzae (teleomorph: Magnaporthe grisea: rice blast) on rice and P. grisea on turf and cereals; Pythium spp. (damping-off) on turf, rice, corn, wheat, cotton, oilseed rape, sunflowers, soybeans, sugar beets, vegetables and various other plants (e. g. P. ultimum or P. aphanidermatum) and P. oligandrum on mushrooms; Ramularia spp., e. g. R. collo-cygni (Ramularia leaf spots, Physiological leaf spots) on barley, R. areola (teleomorph: Mycosphaerella areola) on cotton and R. beticola on sugar beets; Rhizoctonia spp. on cotton, rice, potatoes, turf, corn, oilseed rape, potatoes, sugar beets, vegetables and various other plants, e. g. R. solani (root and stem rot) on soybeans, R. solani (sheath blight) on rice or R. cerealis (Rhizoctonia spring blight) on wheat or barley; Rhizopus stolonifer (black mold, soft rot) on strawberries, carrots, cabbage, vines and tomatoes; Rhynchosporium secalis and R. commune (scald) on barley, rye and triticale; Sarocladium oryzae and S. attenuatum (sheath rot) on rice; Sclerotinia spp. (stem rot or white mold) on vegetables ( S. minor and S. sclerotiorum) and field crops, such as oilseed rape, sunflowers (e. g. S. sclerotiorum) and soybeans, S. rolfsii (syn. Athelia rolfsii) on soybeans, peanut, vegetables, corn, cereals and ornamentals; Septoria spp. on various plants, e. g. S. glycines (brown spot) on soybeans, S. tritici (syn. Zymoseptoria tritici, Septoria blotch) on wheat and S. (syn. Stagonospora) nodorum (Stagonospora blotch) on cereals; Uncinula (syn. Erysiphe) necator (powdery mildew, anamorph: Oidium tuckeri) on vines; Setosphaeria spp. (leaf blight) on corn (e. g. S. turcicum, syn. Helminthosporium turcicum) and turf; Sphacelotheca spp. (smut) on corn, (e. g. S. reiliana, syn. Ustilago reiliana: head smut), sorghum und sugar cane; Sphaerotheca fuliginea (syn. Podosphaera xanthii: powdery mildew) on cucurbits; Spongospora subterranea (powdery scab) on potatoes and thereby transmitted viral diseases; Stagonospora spp. on cereals, e. g. S. nodorum (Stagonospora blotch, teleomorph: Leptosphaeria [syn. Phaeosphaeria] nodorum, syn. Septoria nodorum) on wheat; Synchytrium endobioticum on potatoes (potato wart disease); Taphrina spp., e. g. T. deformans (leaf curl disease) on peaches and T. pruni (plum pocket) on plums; Thielaviopsis spp. (black root rot) on tobacco, pome fruits, vegetables, soybeans and cotton, e. g. T. basicola (syn. Chalara elegans); Tilletia spp. (common bunt or stinking smut) on cereals, such as e. g. T. tritici (syn. T. caries, wheat bunt) and T. controversa (dwarf bunt) on wheat; Trichoderma harzianum on mushrooms; Typhula incarnata (grey snow mold) on barley or wheat; Urocystis spp., e. g. U. occulta (stem smut) on rye; Uromyces spp. (rust) on vegetables, such as beans (e. g. U. appendiculatus, syn. U. phaseoli), sugar beets (e. g. U. betae or U. beticola) and on pulses (e.g. U. vignae, U. pisi, U. viciae-fabae and U. fabae); Ustilago spp. (loose smut) on cereals (e. g. U. nuda and U. avaenae), corn (e. g. U. maydis: corn smut) and sugar cane; Venturia spp. (scab) on apples (e. g. V. inaequalis) and pears; and Verticillium spp. (wilt) on various plants, such as fruits and ornamentals, vines, soft fruits, vegetables and field crops, e. g. V. longisporum on oilseed rape, V. dahliae on strawberries, oilseed rape, potatoes and tomatoes, and V. fungicola on mushrooms; Zymoseptoria tritici on cereals.

In an embodiment, the input data may further comprise a soil moisture indicator, which is obtained by the data processing unit and associated with the location at which the agricultural plant is cultivated. For example, the soil moisture indicator may indicate how wet the soil was or is at a given time, and/or may be for a future time. In other words, the method may comprise an optional step of: obtaining, by the data processing unit, a soil moisture indicator associated with the location at which the agricultural plant is cultivated, wherein the soil moisture indicator is provided to computational model as part of the input data. In this way, a In this way, an even more accurate prediction of the disease probability can be made.

According to an embodiment, the disease probability may be predicted in quantitative value. In other words, the computational model may predict a value that is assigned to a certain probability value or range with which the disease may occur at the plant at all or the course of the disease may have spread beyond a certain threshold. The quantitative value may be between e.g. 0 to 1, 0 to 100, etc., for indicating the disease probability. Alternatively or additionally, the predicted value may be provided as a percentage value from 0 to 100 %. Thus, the disease probability can be precisely predicted and/or estimated with a concrete value for a certain time point or a certain period within the prediction period. Further, a time-related threshold from or after which the course of disease or the disease level is unacceptable, e.g. because of moving to the top leaves, may be determined based on the predicted value.

In an embodiment, the at least one plant protection treatment parameter may comprise a treatment period or a treatment time. In other words, the method is capable of finding a suitable or, preferably, the most appropriate treatment timing, such as a spray timing, at which, for example, a plant protection agent or pesticide can be applied in order to at least control, eliminate or prevent the disease, on the one hand, and to require the smallest possible quantities of the plant protection agent or pesticide, on the other hand. The plant protection treatment parameter may therefore also be referred to as optimum treatment and/or application time.

According to an embodiment, the at least one plant protection treatment parameter may further comprise a date or time window when the controllability of the disease with certain plant protection measures is above a minimum threshold. This may also be referred to as optimum treatment and/or application time.

In an embodiment, the location at which the agricultural plant is cultivated may be a field, e.g. a soil surface, or the like, the field may be divided into a number of sub-fields, and wherein the disease probability may be predicted for at least a part of the number of sub-fields in a sub-field specific manner. For example, a map may be created, which divides the field into the different sub-fields and assigns geographic reference data to them. Then, for one, some or all of the sub-fields, the disease probability may be predicted. In this way, the plant treatment may be controlled individually for each one of the sub-fields, which may, for example, save on plant a protection agent and/or machine operation time resulting from machine treatment of the plant(s).

According to an embodiment, the at least one plant protection treatment parameter may be determined in a sub-field specific manner. In this way, the at least one plant protection treatment parameter may be determined individually for one, some or all of the sub-fields, which may, for example, save on plant a protection agent and/or machine operation time resulting from machine treatment of the plant(s).

In an embodiment, the soil moisture indicator may comprise a soil moisture value associated with one or more soil depths. For example, the soil moisture value may indicate how wet the soil of the field or one or more sub-fields was or is at a given time, and/or may be for a future time. Further, by way of example, the soil moisture value may be derived from microwave radiation measurements, wherein different wavelengths may be used to provide soil moisture values for different depths of the soil. Optionally, C-band microwave radiation may be used to provide and/or determine the soil moisture value of the top 2 cm of the soil, X-band microwave radiation may be used to provide and/or determine the soil moisture value of the top 1 cm of the soil, and L-band microwave radiation may be used to provide and/or determine the soil moisture value of the top 5 cm of the soil. The soil moisture value may be used as input data for the computational model. In this way, a more accurate prediction of the disease probability may be provided.

According to an embodiment, wherein the soil moisture indicator may comprise a soil type. Thereby, different soil types can be assigned to different predispositions for the probability of disease, e.g. by a corresponding classification. In this way, a more accurate prediction of the disease probability may be provided.

In an embodiment, the soil moisture indicator may be modelled and/or calculated, based on soil data and the weather data, wherein the soil data can be one or more of the below data types: soil type, soil quality, soil sandiness, soil humidity, soil temperature, soil surface temperature, soil density, soil texture, soil conductivity, pH value of the soil, and/or water holding capacity of the soil, either relating to the field or to the sub-field. Thereby, different soil data can be assigned to different predispositions for the probability of disease, e.g. by a corresponding classification. In this way, a more accurate prediction of the disease probability may be provided.

In an embodiment, the soil moisture indicator may be modelled and/or calculated, based on at least a soil type and the weather data. Thereby, different soil types can be assigned to different predispositions for the probability of disease, e.g. by a corresponding classification. In this way, a more accurate prediction of the disease probability may be provided.

According to an embodiment, the soil moisture indicator may be at least partly derived from a remote measurement performed to the location at which the agricultural plant is cultivated. For example, the soil moisture, e.g. a soil moisture value, or the like, may be obtained from satellite data. Optionally, C-band microwave radiation may be used to provide and/or determine the soil moisture value of the top 2 cm of the soil, X-band microwave radiation may be used to provide and/or determine the soil moisture value of the top 1 cm of the soil, and L-band microwave radiation may be used to provide and/or determine the soil moisture value of the top 5 cm of the soil. The soil moisture value may be used as input data for the computational model. In this way, a more accurate prediction of the disease probability may be provided.

In an embodiment, the soil moisture indicator may at least partly be derived from a local measurement performed at the location at which the agricultural plant is cultivated. For example, at least one soil moisture sensor may be used to determine the soil moisture and/or the soil moisture indicator. The soil moisture value may be used as input data for the computational model. In this way, a more accurate prediction of the disease probability may be provided.

According to an embodiment, the method may further comprise obtaining a biomass indicator associated with the location at which the agricultural plant is cultivated, wherein the biomass indicator may be additionally provided to the computational model as additional input data for predicting the disease probability. For example, the biomass indicator may be a normalized difference vegetation index (NDVI) and/or leaf area index (LAI). In this way, a more accurate prediction of the disease probability may be provided.

In an embodiment, the computational model may be a computational regression model.

In an embodiment, the at least one plant protection treatment parameter may be used to specify a specification of a plant protection agent to be used. For this purpose, a suitable computational model, or data obtained by a database, etc., may be used. This can further improve quality of the plant treatment.

According to an embodiment, the at least one plant protection treatment parameter and/or the plant treatment plan may be used as a trigger to inform a user, e.g. through a message, an alert, etc., about the at least one plant protection treatment parameter and/or the plant treatment plan, and/or to instruct, based on the at least one plant protection treatment parameter and/or the plant treatment plan, a user carry out certain actions, e.g. at a certain time.

In an embodiment, the at least one plant protection treatment parameter and/or the plant treatment plan may be used to generate a control data set adapted to be provided to a robotic device, which may, for example, be adapted to automatically carry out the plant treatment plan or to apply e.g. a plant protection agent, a pesticide, etc., at a specific date or time. This can further improve efficiency in agriculture.

According to an embodiment, predicting the disease probability of the agricultural plant may further comprise:
Predicting, by the computational model, a disease progression window in which a probable course of disease of the agricultural plant over a time period is computed and being indicative for the disease probability to a specific time within the disease progression window.
The predicted disease probability may be extracted from the disease progression window.

In other words, the computational model is capable of determining a disease progression curve, which may be part of the window. This disease progression curve may be used to identify a threshold after which the disease level is unacceptable, e.g. because of moving to the upper or top leaves of the plant, or the like. This can then be used to determine an optimal application time.

In an embodiment, the plant observation data may comprise one or more of: field data, observed infestation data, and a growth stage associated with the agricultural plant. These data may be combined and/or correlated. According to an embodiment, the field data may comprise one or more of: geographical location information indicative for the geographical location at which the agricultural plant is cultivated, and field data comprising one or more of soil data, field dimensions, field orientation, field environment data.

According to an embodiment, the field data may comprise one or more of: geographical location information indicative for the geographical location at which the agricultural plant is cultivated, soil data, field dimensions, field orientation, field environment data. These data may be combined and/or correlated. In at least some embodiments, the computational model may comprise a number of layers, which number may be based on the number, plurality etc. of input data to be processed. If additional layers are introduced, further data and/or parameters may be considered for the prediction. For example, it may additionally consider soil moisture, etc.

In an embodiment, the predicted disease probability indicates or comprises one or more of a disease severity, a disease incident, and a disease risk. Preferably, it indicates disease severity, since it has been found that one day of high infection risk is not yet necessarily problematic, wherein a continuous high risk over several days can lead to disease appearance. Disease severity, however, which is the amount of diseases that is visible on a plant, may be seen as the result of a number of infection risk days.

According to an embodiment, the computational regression model utilizes an artificial neural network adapted to output data in response to the input plant observation data and weather data. The neural network may consist of a plurality of layers, wherein each layer comprises one or more neurons. Neurons between adjacent layers are linked in that the outputs of neurons of a first layer are the inputs of one or more neurons in an adjacent second layer. Each such link is given a “weight” with which the corresponding input goes into an “activation function” that gives the output of the neuron as a function of its inputs. The activation function is typically a nonlinear function of its inputs. For example, the activation function may comprise a “pre-activation function” that is a weighted sum or other linear function of its inputs, and a threshold function or other nonlinear function that produces the final output of the neuron from the value of the pre-activation function. In the neural network used to carry out the present method, the weights are set or adjusted by training with suitable training data before the prediction is made. In at least some embodiments, the neural network may be implemented with techniques such as Pytorch and/or FastAl.

In at least some embodiments, the computational model may be a time-aware computational model. For example, the model may comprise a further layer adapted to process time-dependent input data that comprises, for example, a time stamp, or the like, to map input value to a time point or period. This can further improve the learning and/or prediction abilities of the computational model.

Further, alternatively or additionally, the computational model may comprise or may be formed as a recurrent neural network (RNN), where connections between nodes form a directed graph along a temporal sequence. This can further improve the learning and/or prediction abilities of the computational model.

Alternatively or additionally, the computational model may comprise or may be formed as an Long short-term memory (LSTM) architecture, which is an artificial recurrent neural network (RNN) architecture. This can further improve the learning and/or prediction abilities of the computational model.

In an embodiment, the plant protection treatment parameter and/or the plant protection treatment plan may be provided as a computer-readable dataset adapted to be executed by a data processing device. For example, the plant protection treatment parameter and/or the plant protection treatment plan may be provided as a message, e.g. to be received by a terminal, such as a smartphone, or any other suitable computer device. It may also be used to control a robot to use the protection treatment parameter and/or carry out the plant protection treatment plan.

According to an embodiment, the computational model may further obtain scouting information and/or user feedback, collected and/or captured during cultivation season. The scouting information may be obtained from e.g. a computer application (App). The scouting information may comprise, for example, one or more scouting images taken at the location of the plant.

Scouting imaging may be subject to imaging processing, such as image analysis, pattern recognition, or the like. The user feedback may be based on e.g. manual observation, at least semi-automated detection, etc. It may also be input via the same or another computer App. In at least some embodiments, the obtained scouting information and/or user feedback may be used to adapt and/or calibrate the computational model during cultivation season of the plant. This can further improve the learning and/or prediction abilities of the computational model.

A second aspect of the invention provides a method for adapting a computational model to changed conditions of cultivation of an agricultural plant for determining, by use of the adapted computational model, a plant protection treatment plan for the agricultural plant. The method is preferably computer-implemented and carried out by a data processing unit. This may be the above data processing unit or computer device. The method comprises the steps of:

Providing, to the computational model, training data as input data at least comprising one or more of field specific data, observed disease severity, growth stage data, and weather data, the input data associated with changed conditions of cultivation of the agricultural plant.

The field specific data may refer to data collected with experimental trials. Field trials are a standard way in agriculture to study the effect of seed varieties, susceptibilities, effect of fungicide and other specific farming activities. For example, as part of these studies different plot designs or trial setup may be devised and different aspects are recorded throughout the growing period by trial operators which is later analyzed and studied by trial operators. In this study the data from untreated plots in the trial are used to study how the disease would progress in case no actions are taken by the farmer. This allows for studying the dynamics of the disease and hence device management strategies better. As part of this process, the planting date, crop data (such as crop type) and location details of trial may further be used. These field specific data may be computationally processed to provide the input data in electronic form. The field specific data may be obtained electronically by suitable detection and/or collection means, such as optical detection means, e.g. by remote-controlled or at least partially autonomous robots, satellite imaging, or the like. Further, the field specific data may be correlated with the observed disease severity and/or the growth stage and/or the weather data. In an embodiment, field specific data include data relating to the planting date and crop data, wherein crop data include data relating to crop type, crop species, crop varieties, crop genetic information, susceptibilities of crops regarding specific diseases. Field-specific data, data relating to the planting date, and crop data can be obtained through measurements (including sensor measurements based on e.g. remote sensing, proximal sensing), modeling, or user input. “Genetic information” is understood to be any kind of information on the genetic properties of an organism, including but not limited to DNA sequence, RNA sequence, parts of DNA and/or RNA sequences, molecular structure of DNA and/or RNA, epigenetic information (e.g. methylation of DNA parts), information on gene mutations, information on gene copy number variation, information on overexpression of a gene, information on expression level of a gene, information on gene shifting, information on the ratio between wild type and mutants, information on the ratio between different mutants, information on the ratio between mutants and other variants (e.g. epi-genetic variants), information on the ratio of different variants (e.g. epigenetic variants), and also includes the information that certain wild types, mutants, or variants (e.g. epigenetic variants) or DNA/RNA sequences, or parts of the DNA/RNA sequences, or specific epigenetic information are absent.

The observed disease severity and/or the growth stage data may be obtained from determining, by observation, disease severity at different growth stage of the agricultural plant throughout the growing period. Further, the observed disease severity and/or the growth stage data may be correlated with the field specific data and/or the weather data.

The weather data may refer to historical weather data, and may be derived, via a suitable application programming interface (API), from e.g. a weather database, weather station networks, and simulated data from a suitable weather model. Further, the weather data may be correlated with the field specific data and/or the observed disease severity and/or growth stage data.

Before providing the above data as training data to the computational model, one or more of the field specific data, observed disease severity, growth stage data, and weather data may be preprocessed. For example, observations may be made per observation date, and the values from same day may be averaged. Further, as planting date may be a crucial parameter, trials with missing planting dates may be discarded. Further, trials may miss geo coordinate details, wherein for such trials a location estimation may be estimated based on further information available for the location, such as a designation of city or town, and/or by reverse geo coding.

Further, before providing the above data as training data to the computational model, the above data may be subject to a disease progression analysis. For example, observations made in trials may aim to capture the temporal disease development which is the amount of disease present in a population of plants when assessed several times over the growing season. Such assessments may be made for disease severity over different leaf layers. In particular, a weighted sum technique may be used to sum the different leaf layer specific disease severity values based on their effect to the final yield. This results in a more understandable, simplified, smoother curve of disease progression over time. Based on these temporal disease development values a disease progress curve may be prepared which is a collective presentation depicting the dynamics of disease development with time. This temporal progress curve represents outcomes of complex interactions between host, pathogen, environments and crop husbandry. A method used to describe temporal disease progress is the use of a suitable growth model.

Adjusting, by using backpropagation, based on the training data, parameters or weights of the computational model to adapt the computational model to the changed conditions of cultivation of an agricultural plant.

For example, the computational model may be formed as or may utilize a neural network. In general, the neural network may consist of a plurality of layers, wherein each layer comprises one or more neurons. Neurons between adjacent layers are linked in that the outputs of neurons of a first layer are the inputs of one or more neurons in an adjacent second layer. Each such link is given a “weight” with which the corresponding input goes into an “activation function” that gives the output of the neuron as a function of its inputs. The activation function is typically a nonlinear function of its inputs. For example, the activation function may comprise a “pre-activation function” that is a weighted sum or other linear function of its inputs, and a threshold function or other nonlinear function that produces the final output of the neuron from the value of the pre-activation function. In the neural network used to carry out the present method, the weights are set or adjusted by training with suitable training data before the prediction is made.

Further, backpropagation is known in the field of machine learning, and refers to an algorithm used in e.g. training feedforward neural networks for supervised learning. Backpropagation may compute a gradient of a loss function with respect to weights of the network to fit the neural network. Backpropagation utilized to train a feedforward network is able to perform nonlinear multiple regressions. The goal of a feedforward network is to approximate a function f such that y = f(x; θ) where f maps all input data and parameters θ to give a value y of the disease probability which is a value between, for example, 0 to 1 or 0 to 100%. With backpropagation technique repeated adjustment to the parameters θ may be made so as to minimize the difference between actual output and desired output. The input data may be a combination of categorical and continuous values. Continuous values can be used as input data without further pre-processing but the categorical values may profit from pre-processing. In at least some embodiments, it may further improve the backpropagation by representing values in a categorical column is in the form of an N-dimensional vector, instead of a single integer. A vector is capable of capturing more information and can find relationships between different categorical values in a more appropriate way. The input data may be fed into a multi-layer feedforward neural network. This means the network contains multiple layers of hidden neurons. The hidden layers are used to increase the non-linearity and change the representation of the data for better generalization over the function. Since this is a complex tabular data analysis task this layer contains, for example, a number of, e.g. hundreds or thousands, output neurons, and preferably, in a two-layer network 500 to 1500, preferably about 1,000, and 200 to 800, preferably about 500, output neurons respectively. Thereby, for example, a matrix multiplication is a linear function. The non-linearity used may be, for example, a rectified linear unit (ReLU). As the generalization capability is increased, there is an increase of the risk of overfitting the data. To avoid this, dropout regularization may be used. Alternatively or additionally, so-called Batch Normalization may also be applied after the non-linearity to avoid overfitting. Further, so-called Batch normalization may also be performed to improve the speed, performance, and stability of the neural network. It may particularly be used to normalize the input layer by adjusting and scaling the activations. The output layer receives as input output activations from the last layer, a corresponding number inputs, for example, 200 to 800, preferably about 500. Optionally, a linear transformation may be performed to obtain one output, namely the predicted disease probability value in a range between 0 to 1 which may then be mapped to a value between 0 to 100%. Thus, backpropagation may be used to train the computational model.

Using the adapted computational model for determining the plant protection treatment plan of the agricultural plant by predicting at least a time-related disease probability of the agricultural plant.

After training and adaption, the computational model is adapted to the changed conditions of cultivation. Therefore, it may be used for accurately determining the plant protection treatment plan of the agricultural plant for new weather conditions, new diseases and/or new regions.

According to an embodiment, the method may further comprise, before providing training data as input data, the step of:
Combining the field specific data, observed disease severity, growth stage data, and weather data to combined data.
Processing the combined data by a weighted sum function to sum different leaf layer specific disease probability values based on their effect to a final yield of the agricultural plant.

A third aspect of the invention provides a device for determining a plant protection treatment plan of an agricultural plant. The device comprises a data interface adapted to receive data and/or output data, and a data processing unit. The data processing unit is adapted to:
Predict, by use of a computational model executed by the data processing unit, based on obtained observation data, optionally obtained soil moisture data, and obtained weather data, a time-related disease probability of the agricultural plant.
Determine, by use of the computational model, based on at least the predicted disease probability, at least one plant protection treatment parameter to be included in the plant protection treatment plan.

Preferably, the device may be adapted to perform the method of the first aspect.

A fourth aspect of the invention provides a device for adapting a computational model to changed conditions of cultivation of an agricultural plant for determining, by use of the adapted computational model, a plant protection treatment plan for the agricultural plant. The device comprises a data interface adapted to receive data and/or output data, and a data processing unit. The data processing unit is adapted to:
Obtaining, by the computational model, training data at least comprising one or more of field specific data, observed disease severity, growth stage data, optionally soil moisture data, and weather data, the training data associated with changed conditions of cultivation of the agricultural plant.
Adjusting, by using backpropagation, based on the training data, parameters or weights of the computational model to adapt the computational model to the changed conditions of cultivation of the agricultural plant.
Using the adapted computational model for determining the plant protection treatment plan of the agricultural plant by predicting at least a time-related disease probability of the agricultural plant.

Preferably, the device may be adapted to perform the method of the second aspect.

A fifth aspect of the invention provides a system for treating an agricultural plant based on a plant protection treatment plan assigned to the agricultural plant. The system comprises:
A first device, comprising a data interface adapted to receive data and/or output data, and a data processing unit. The data processing unit is adapted to:
Predict, by use of a computational model executed by the first data processing unit, based on obtained observation data, optionally obtained soil moisture data, and obtained weather data, a time-related disease probability of the agricultural plant, and
Determine, by use of the computational model, based on at least the predicted disease probability, at least one plant protection treatment parameter to be included in the plant protection treatment plan, and
Provide output data at least comprising the at least one plant protection treatment parameter.
A second device, comprising a data interface adapted to receive data and/or output data, and a data processing unit. The data processing unit is adapted to:
Obtain the output data from the first data processing unit.
Process the obtained output data to use the at least one plant protection treatment parameter.

The system may be a distributed computer system, wherein the first and second device may be connected via a communications network, such as the Internet. For example, the first device may be a server, a cloud, or the like, and may be adapted to centrally carrying out the above steps. Further, the second device may be located remotely to the first device. The second device may be any kind of computer device, terminal, such as a smartphone, a controller of robot device, or the like. For example, if the plant protection treatment parameter indicates a timing for plant treatment, the output data of the first device may comprise a message to be sent to and received by e.g. the terminal, so as to inform the user about the predicted timing for plant treatment. Further, the output data of the first device may trigger the robot device to carrying out plant treatment.

A sixth aspect of the invention provides computer program element for determining a plant protection treatment plan of an agricultural plant, the computer program, when being executed by a data processing unit and/or computer device, is adapted for carrying out the method according to the first and/or second aspect.

These and other aspects of the present invention will become apparent from and elucidated with reference to the embodiments described hereinafter.

Exemplary embodiments of the invention will be described in the following with reference to the following drawings.

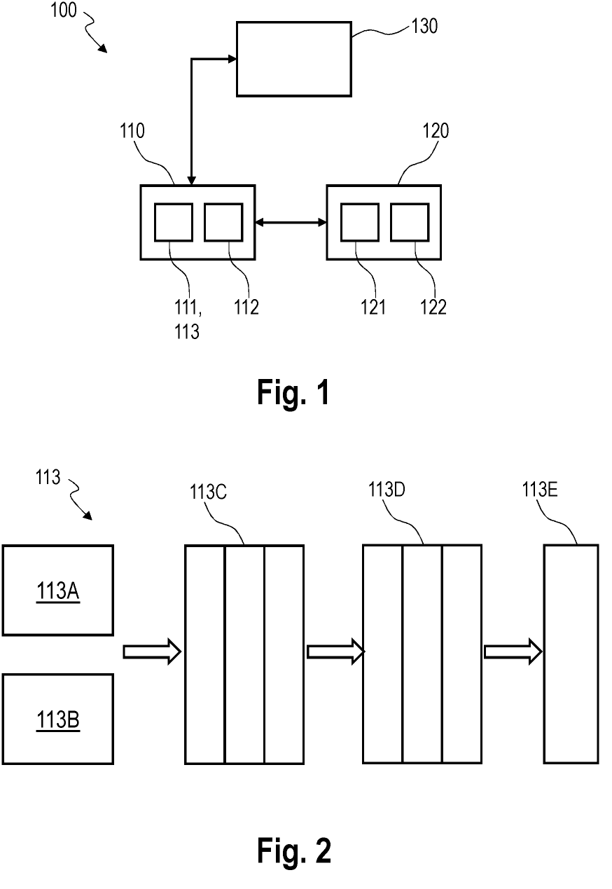

FIG. 1 shows a schematic block diagram of a system for treating an agricultural plant according to an embodiment of the invention.

FIG. 2 shows in a schematic block diagram an architecture of a computational model adapted to determine a plant protection treatment plan of the agricultural plant according to an embodiment of the invention.

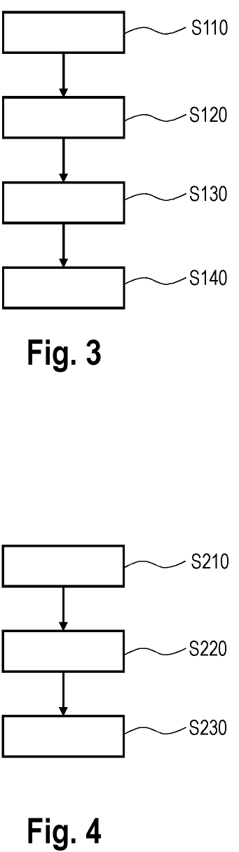

FIG. 3 shows a flow chart of method for determining a plant protection treatment plan of an agricultural plant according to an embodiment of the invention.

FIG. 4 shows a flow chart of a method for adapting a computational model to changed conditions of cultivation of an agricultural plant according to an embodiment of the invention.

The drawings are merely schematic representations and serve only to illustrate the invention. Identical or equivalent elements are consistently provided with the same reference signs.

FIG. 1 shows in a schematic block diagram a system 100 for treating an agricultural plant.

The system 100 comprises a first device 110 adapted for determining a plant protection treatment plan of the agricultural plant, as will be described in more detail below. The first device 110 may be a suitable type of computer and comprises a data interface 111 adapted to receive data and/or output data and a data processing unit 112. It may also comprise a data storage, memory, or the like. Optionally, the data interface 111 may be adapted to communicate via a communications network, such as the Internet. In some embodiments, the first device 110 may form or may be part of a computing cloud, a server, or the like. In other embodiments, the first device 110 may be a local computer device. The first device 110 is adapted to computationally execute a computational model 113 (see e.g. FIG. 2) that is adapted for determining a plant protection treatment plan of the agricultural plant, as will be described in more detail below.

Further, the system 100 comprises a second device 120 adapted to at least obtain and/or process output data obtained from the first device 110. In other words, output data of the first device 110 may be used by the second device 120 for treatment of the agricultural plant. For example, the second device 120 may receive the a plant protection treatment plan of the agricultural plant from the first device 110. The second device 120 may be a suitable type of computer and comprises a data interface 121 adapted to receive data and/or output data and a data processing unit 122. It may also comprise a data storage, memory, or the like. Optionally, the data interface 121 may be adapted to communicate via a communications network, such as the Internet. In at least some embodiments, the second device 140 may be located remotely to the first device 110 and/or second device 120, for example at or near the location of the agricultural plant. Further, optionally, the second device 120 may be a terminal, such as a smartphone, a robotic device, or the like.

Furthermore, the system 100 comprises or is operatively connected to at least one data source 130 adapted to collect and/or provide data to be input to the first device 110 and/or the second device 120. The data source 130 may exemplary represent a plurality of different data sources, such as a weather station, a weather station network, a database comprising observed plant data, etc. It may comprise training data at least comprising one or more of field specific data, observed disease severity, growth stage data, and weather data, wherein the training data associated with changed conditions of cultivation of the agricultural plant. Further, the data source 130 may comprise plant observation data indicative for a current state of health of the agricultural plant or of a reference plant and weather data associated with a location at which the agricultural plant is cultivated.

The data source 130, the first device 110 and/or the second device 120 may at least partly operatively connected to each other, as indicated in FIG. 1 by respective arrows between the entities shown, wherein a data flow between the entities can be identified by the direction of the arrows.

The above system 100 may be operated as described below.

The first device 110 may be adapted to determine a plant protection treatment plan of an agricultural plant. In particular, the first device 110 is adapted to obtain, e.g. by the data processing unit 112 via the data interface 111, plant observation data indicative for a current state of health of the agricultural plant or of a reference plant from the data source 130. Further, the first device 110 is adapted to obtain, by the data processing unit 112 via the data interface 111, weather data associated with a location at which the agricultural plant is cultivated from the data source 130. The first device 110 is further adapted to predict, by the above computational model 113 preferably stored in or loaded to e.g. a data storage of the first device 110 and executed by the data processing unit 112, based on the obtained observation data, the obtained weather data, and, optionally, a soil moisture indicator, a time-related disease probability of the agricultural plant. Further, the first device 110 is adapted to determine, by the computational model 113, based on at least the predicted disease probability, at least one plant protection treatment parameter to be included in the plant protection treatment plan. The computational model 113 may be formed as or may utilize a neural network adapted to output data in response to the input plant observation data and weather data. The computational model 113 may be adapted to process the input data to compute the disease probability in a quantitative value, e.g. in a value of 0 to 1 or 0 to 100. In at least some embodiments, the at least one plant protection treatment parameter comprises a treatment period or a treatment time. For example, the at least one plant protection treatment parameter comprises a date or time window when the controllability of the disease with certain plant protection measures is above a minimum threshold. Further, in at least some embodiments, the first device 110 and/or the computational model 113 is adapted to predict, by the computational model 113, a disease progression window in which a probable course of disease of the agricultural plant over a period of time is computed and being indicative for the disease probability to a specific time within the disease progression window, wherein the predicted disease probability is extracted from the disease progression window. Further, in at least some embodiments, the first device 110 and/or the computational model 113 is adapted to process the plant observation data by use of a weighted sum function adapted to sum different leaf layer specific disease probability based on their effect to the yield of the plant. For example, the plant observation data comprises one or more of: field data, observed infestation data, and a growth stage associated with the agricultural plant. Further, the predicted disease probability indicates or comprises one or more of a disease severity, a disease incident, and a disease risk. The plant protection treatment parameter and/or the plant protection treatment plan is provided as a computer-readable dataset adapted to be executed by a data processing device, e.g. by the second device 120.

Optionally, the location at which the agricultural plant is cultivated may be a field, the field may be divided into a number of sub-fields, and wherein the disease probability may be predicted for at least a part of the number of sub-fields in a sub-field specific manner. For example, the field may be divided by utilizing a map, e.g. a digital and/or computer-readable map, indicating different sub-fields. Based on the division into a number of sub-fields, the at least one plant protection treatment parameter may be determined in a sub-field specific manner, and wherein, for example, the at least one protection treatment parameter may be individually determined for each specific sub-field.

Further optionally, the soil moisture indicator comprises a soil moisture value associated with one or more soil depths. In at least some embodiments, the soil moisture indicator may comprise a soil type. Further optionally, the soil moisture indicator may be modelled, predicted, and/or calculated based on at least a soil type and the weather data. Further, the soil moisture indicator may at least partly be derived from a remote measurement performed to the location at which the agricultural plant is cultivated. Alternatively or additionally, the soil moisture indicator may at least partly be derived from a local measurement performed at the location at which the agricultural plant is cultivated.

In at least some embodiments, a biomass indicator, such as LAI and/or NDVI, which may be derived from satellite data, associated with the location at which the agricultural plant is cultivated may obtained. Thereby, the biomass indicator may be additionally provided to the computational model 113 as additional input data for predicting the disease probability.

The computational model 113 executed by the first device 110 may be adapted to changed conditions of cultivation of the agricultural plant for determining, by use of the adapted computational model 113, a suitable plant protection treatment plan for the agricultural plant. For this purpose, the first device 110 is adapted to obtain, by the computational model 113, e.g. via the data interface 112, training data at least comprising one or more of field specific data, observed disease severity, growth stage data, and weather data, the training data associated with changed conditions of cultivation of the agricultural plant. Further, the first device 110 is adapted to adjust, by using backpropagation, based on the training data, parameters or weights of the computational model 113 to adapt the computational model 113 to the changed conditions of cultivation of the agricultural plant. Then, the adapted computational model 113 may be used for determining the plant protection treatment plan of the agricultural plant by predicting at least a time-related disease probability of the agricultural plant, as described above.

FIG. 2 shows in a schematic block diagram an exemplary architecture of the above computational model 113, which is here a multi-layer neural network. By way of example, the computational model 113 is a two-layer feedforward neural network adapted to be trained by backpropagation, such as a backpropagation algorithm. Accordingly, the computational model 133 comprises a first layer 113A and a second layer 113B. As designated in FIG. 2 by blocks 113C and 113D, the input data, which may comprise categorical values (see block 113C) and continuous values (see block 113D), are fed into the neural network, and particularly into the first layer 113A. The first layer 113A and the second layer 113B may be interconnected. Each of the first layer 113A and the second layer 113B may comprise a linear function, comprising e.g. a matrix multiplication, and a non-linearity function, comprising e.g. a rectified linear unit (ReLU). The output, via block 113E, of the computational model 113 may be the above predicted at least one plant protection treatment parameter to be included into the plant protection treatment plan, or the complete plant protection treatment plan including the at least one plant protection treatment parameter.

FIG. 3 shows a flow chart of a method for determining the plant protection treatment plan of the agricultural plant. It is noted that the following method steps, in particular the obtaining of the input data, do not necessarily have to be carried out in the specified order, but the input data may also be obtained in a different order. In a step S110, plant observation data indicative for a current state of health of the agricultural plant or of a reference plant is obtained, e.g. by the data processing unit 111. In a step S120, weather data associated with a location at which the agricultural plant is cultivated is obtained, by e.g. the data processing unit 111. Optionally, a soil moisture indicator associated with the location at which the agricultural plant is cultivated may be obtained, by e.g. the data processing unit 111. In a step S130, based on input data at least comprising the obtained observation data and the obtained weather data and, optionally, the obtained soil moisture indicator, a time-related disease probability of the agricultural plant is predicted, by the computational model 113 executed by the data processing unit 111. In a step S140, based on at least the predicted disease probability, at least one plant protection treatment parameter to be included in the plant protection treatment plan is determined, e.g. by the computational model 113 executed by e.g. the data processing unit 111.

FIG. 4 shows a flow chart of a method for adapting the computational model 113 to changed conditions of cultivation of an agricultural plant for determining, by use of the adapted computational model 113, the plant protection treatment plan for the agricultural plant. In a step S210, training data at least comprising one or more of field specific data, observed disease severity, growth stage data, weather data, and, optionally, a soil moisture indicator, wherein the training data associated with changed conditions of cultivation of the agricultural plant, is obtained by the computational model 113. In a step S220, based on the training data, parameters or weights of the computational model 113 are adjusted to adapt the computational model 113 to the changed conditions of cultivation of the agricultural plant, by using backpropagation. In a step S230, the adapted computational model 113 is used for determining the plant protection treatment plan of the agricultural plant by predicting at least a time-related disease probability of the agricultural plant.

It is noted that embodiments of the invention are described with reference to different subject-matters. In particular, some embodiments are described with reference to method type claims whereas other embodiments are described with reference to the device type claims. However, a person skilled in the art will gather from the above and the following description that, unless otherwise notified, in addition to any combination of features belonging to one type of subject matter also any combination between features relating to different subject matters is considered to be disclosed with this application. However, all features can be combined providing synergetic effects that are more than the simple summation of the features.

While the invention has been illustrated and described in detail in the drawings and foregoing description, such illustration and description are to be considered illustrative or exemplary and not restrictive. The invention is not limited to the disclosed embodiments. Other variations to the disclosed embodiments can be understood and effected by those skilled in the art in practicing a claimed invention, from a study of the drawings, the disclosure, and the dependent claims.

In the claims, the word “comprising” does not exclude other elements or steps, and the indefinite article “a” or “an” does not exclude a plurality. A single processor or other unit may fulfil the functions of several items re-cited in the claims. The mere fact that certain measures are re-cited in mutually different dependent claims does not indicate that a combination of these measures cannot be used to advantage. Any reference signs in the claims should not be construed as limiting the scope.

1. A method for determining a plant protection treatment plan of an agricultural plant, the method carried out by a data processing unit (111), and the method comprising the steps of:
obtaining (S110), by the data processing unit, plant observation data indicative for a current state of health of the agricultural plant or of a reference plant,
obtaining (S120), by the data processing unit, weather data associated with a location at which the agricultural plant is cultivated,
predicting (S130), by a computational model (113) executed by the data processing unit, based on input data at least comprising the obtained observation data and the obtained weather data, a time-related disease probability of the agricultural plant, and
determining (S140), by the computational model (113), based on at least the predicted disease probability, at least one plant protection treatment parameter to be included into the plant protection treatment plan.

2. The method according to claim 1, wherein the input data further comprises a soil moisture indicator, obtained by the data processing unit and associated with the location at which the agricultural plant is cultivated.

3. The method according to claim 1, wherein the at least one plant protection treatment parameter comprises a treatment period or a treatment time.

4. The method according to claim 1, wherein the at least one plant protection treatment parameter comprises a date or time window when the controllability of the disease with certain plant protection measures is above a minimum threshold.

5. The method according to claim 1, wherein the location at which the agricultural plant is cultivated is a field, the field is divided into a number of sub-fields, and wherein the disease probability is predicted for at least a part of the number of sub-fields in a sub-field specific manner, and wherein the at least one plant protection treatment parameter is determined in a sub-field specific manner.

6. (canceled)

7. The method according to claim 1, wherein the soil moisture indicator comprises a soil moisture value associated with one or more soil depths.

8. The method according to claim 1, wherein the soil moisture indicator comprises a soil type.

9. The method according to claim 1, wherein the soil moisture indicator is modelled based on at least a soil type and the weather data.

10. The method according to claim 1, wherein the soil moisture indicator is at least partly derived from a remote measurement performed to the location at which the agricultural plant is cultivated.

11. The method according to claim 1, wherein the soil moisture indicator is at least partly derived from a local measurement performed at the location at which the agricultural plant is cultivated.

12. The method according to claim 1, further comprising:
obtaining a biomass indicator associated with the location at which the agricultural plant is cultivated,
wherein the biomass indicator is additionally provided to the computational model (113) as additional input data for predicting the disease probability.

13. The method according to claim 1, wherein predicting the disease probability of the agricultural plant further comprises:
predicting, by the computational model (113), a disease progression window in which a probable course of disease of the agricultural plant over a period of time is computed and being indicative for the disease probability to a specific time within the disease progression window,
wherein the predicted disease probability is extracted from the disease progression window.

14. The method according to claim 1, wherein the plant observation data is obtained and/or processed leaf-layer-specific.

15. The method according to claim 1, wherein the plant observation data is weighted for or classified into different leaf layers of the agricultural plant or the reference plant, based on the different leaf layer’s effect to the yield of the agricultural plant, and wherein the disease probability is predicted based on the weighted or classified plant observation data.

16. The method according to claim 1, wherein the plant observation data comprises one or more of: field data, observed infestation data, and a growth stage associated with the agricultural plant.

17. The method according to claim 1, wherein the predicted disease probability indicates or comprises one or more of a disease severity, a disease incident, and a disease risk.

18. The method according to claim 1, wherein the computational model (113) utilizes a neural network adapted to output data in response to the input plant observation data and weather data.

19. The method according to claim 1, wherein the at least one plant protection treatment parameter and/or the plant protection treatment plan is provided as a computer-readable dataset adapted to be executed by a data processing device of a robotic device to apply a plant protection agent at a specific date or time.

20. (canceled)

21. A method for adapting a computational model (113) to changed conditions of cultivation of an agricultural plant for determining, by use of the adapted computational model (113), a plant protection treatment plan for the agricultural plant, the method carried out by a data processing unit (111), and the method comprising the steps of:
obtaining, by the computational model (113), training data at least comprising one or more of field specific data, observed disease severity, growth stage data, and weather data, the training data associated with changed conditions of cultivation of the agricultural plant,
adjusting, by using backpropagation, based on the training data, parameters or weights of the computational model (113) to adapt the computational model (113) to the changed conditions of cultivation of the agricultural plant, and
using the adapted computational model (113) for determining the plant protection treatment plan of the agricultural plant by predicting at least a time-related disease probability of the agricultural plant.

22. (canceled)

23. (canceled)

24. A system for treating an agricultural plant based on a plant protection treatment plan assigned to the agricultural plant, comprising:
a first data processing unit (111), adapted to:
predict, by use of a computational model (113) executed by the first data processing unit (111), based on obtained observation data and obtained weather data, a time-related disease probability of the agricultural plant, and
determine, by use of the computational model (113), based on at least the predicted disease probability, at least one plant protection treatment parameter to be included in the plant protection treatment plan, and
providing output data at least comprising the at least one plant protection treatment parameter, and
a second data processing unit (121), adapted to:
obtain the output data from the first data processing unit (111), and
process the obtained output data to use the at least one plant protection treatment parameter.

25. (canceled)
